(19) United States
(12) Patent Application Publication
(10) Pub. No.: US 2022/0237695 A1
(43) Pub. Date: Jul. 28, 2022

(54) ELECTRIC POWER BROKERAGE METHOD AND SYSTEM WITH ENHANCED DATA CONFIDENTIALITY AND INTEGRITY BASED ON BLOCKCHAIN

(71) Applicant: Electronics and Telecommunications Research Institute, Daejeon (KR)

(72) Inventors: Tae in HWANG, Daejeon (KR); Il Woo LEE, Daejeon (KR)

(73) Assignee: Electronics and Telecommunications Research Institute, Daejeon (KR)

(21) Appl. No.: 17/488,899

(22) Filed: Sep. 29, 2021

(30) Foreign Application Priority Data
Jan. 28, 2021 (KR) 10-2021-0012366

(51) Int. Cl. G06Q 40/04; G06Q 20/38; G06Q 50/06; H04L 9/32

(52) U.S. Cl. CPC G06Q 40/04; G06Q 20/389; G06Q 50/06; G06Q 20/38215; H04L 9/3236; G06Q 20/3827; G06Q 20/3829; H04L 9/3247; G06Q 20/3825

(57) ABSTRACT

Provided are a power brokerage method and a power brokerage system, and the power brokerage system stores encrypted power brokerage and trading information and a digitally signed hash value in a blockchain distributed ledger through a smart contract code running on a blockchain platform and allows the same to be retrieved. Also, the power brokerage system protects sensitive information related to a brokerage trading contract, a bid, and a settlement by allowing a participant participating in the power market to retrieve original data related to power brokerage and trading information from a power trading server and to compare and verify data forgery/falsification and, at the same time, ensures data integrity and transparency of a brokerage contract and trading.

### CROSS-REFERENCE TO RELATED APPLICATION

This application claims the benefit of Korean Patent Application No. 10-2021-0012366 filed on Jan. 28, 2021, in the Korean Intellectual Property Office, the entire disclosure of which is incorporated herein by reference for all purposes.

### BACKGROUND

### 1. Field of the Invention

One or more example embodiments relate to a power brokerage method and a power brokerage system with enhanced data confidentiality and integrity based on a blockchain, and more particularly, to a method and system that may perform a smart contract-based brokerage contract and trading to ensure data integrity and transparency of a power brokerage and trading.

2. Description of the Related Art

The existing power brokerage market and power brokerage system are built using a closed and centralized system method. In the centralized system method, although information related to a power brokerage contract, bid, and settlement managed by a brokerage company server and a power brokerage market server is forged and falsified by an insider, it is difficult for a participant of the power brokerage market to prove or verify the corresponding forgery and falsification.

Also, in performing a settlement for a power trading made in a brokerage company or a power exchange, the centralized system method has difficulty in verifying whether aggregated energy resource sales revenues are accurately calculated without forgery or falsification based on collected power metering data and contract terms.

Accordingly, in performing a power brokerage and trading, there is a need for a method that may verify whether power trading information between power market participants is forged and falsified.

### SUMMARY

Example embodiments provide a method and system that may protect sensitive information of power market participants and, at the same time, ensure data integrity and transparency by storing, in a blockchain distributed ledger, encrypted power brokerage and trading information and a digitally signed hash value of the power brokerage and trading information through a smart contract code running on a blockchain platform and sharing the same with power market participants.

According to an aspect, there is provided a power brokerage system including a smart contract blockchain device configured to generate a transaction related to a power trading through a smart contract code running on a blockchain platform and to store the generated transaction in a blockchain distributed ledger; a smart power meter configured to request the smart contract blockchain device for execution of the smart contract code and to store a transaction including a digitally signed hash value of metering information in the blockchain distributed ledger; a power trading server configured to request the smart contract blockchain device for execution of the smart contract code related to a settlement and to store a transaction including a digitally signed hash value and a cryptographic text of settlement information in the blockchain distributed ledger; a power brokerage server configured to request the smart contract blockchain device for execution of the smart contract code related to a brokerage contract or a bid, and to store a transaction including a digitally signed hash value and a cryptographic text of the brokerage contract or the bid in the blockchain distributed ledger; and a brokerage contract client configured to verify whether brokerage contract information managed by at least one of the power trading server and the power brokerage server is forged and falsified using the digitally signed hash value of the blockchain distributed ledger.

The smart contract blockchain device may be configured to execute the smart contract code in response to a request from at least one of the power trading server and the power brokerage server and to generate at least one transaction among a brokerage contract transaction, a bid transaction, and a settlement transaction.

The smart contract blockchain device may be configured to store the transaction in the blockchain distributed ledger and then provide a transaction identification (ID) for a transaction search in the blockchain distributed ledger to at least one of the power trading server, the power brokerage server, and the smart power meter.

The power trading server may be configured to generate settlement information according to the metering information received from the smart power meter, to store original data related to the metering information and the settlement information in an off-chain database, and share the same with a user having an access right.

The power brokerage server may be configured to store original data related to the brokerage contract and the bid in an off-chain database and to share the same with a user having an access right.

The smart power meter may be configured to transfer a transaction ID and original data related to the metering information to the power brokerage server.

According to another aspect, there is provided a power brokerage method including generating a cryptographic text in which power brokerage and trading information is encrypted using a public key encryption scheme to share the power brokerage and trading information through a blockchain distributed ledger; generating a digitally signed hash value for the generated cryptographic text by applying a hash algorithm; requesting a smart contract blockchain device for execution of a smart contract code and then generating a transaction including the cryptographic text and the digitally signed hash value, and storing the transaction in the blockchain distributed ledger; and storing, in an off-chain database, a transaction ID for searching for the transaction stored in the blockchain distributed ledger and original data related to the cryptographic text.

The generating of the digitally signed hash value may include generating a hash value corresponding to the cryptographic text based on the hash algorithm; and generating a digitally signed hash value through digital signature for the generated hash value.

According to still another aspect, there is provided a power brokerage method including retrieving, by a brokerage contract client, a transaction ID and original data of power brokerage and trading information stored in an off-chain database; requesting a smart contract blockchain device for execution of the smart contract code using the retrieved transaction ID and searching for a transaction including a cryptographic text and a digitally signed hash value; generating a hash value for authenticity verification by encrypting the original data of the power brokerage and trading information stored in the off-chain database; and comparing the digitally signed hash value and the hash value for authenticity verification and verifying the authenticity of a power brokerage and trading.

The verifying may include decrypting the digitally signed hash value with a public key of a digital signer and generating the decrypted hash value; and determining whether the decrypted hash value and the hash value for authenticity verification match and verifying the authenticity of the power brokerage and trading.

According to still another aspect, there is provided a power brokerage method including concluding a power brokerage contract for a distributed energy resource through a smart contract code of a smart contract blockchain device; registering bid information about aggregated energy resource power sales to a blockchain distributed ledger according to the power brokerage contract; settling a power sales revenue corresponding to a bidding result; and verifying the authenticity of a smart contract-based power brokerage and trading in response to the power brokerage contract, bid, or settlement.

The concluding of the power brokerage contract may include registering, by a power trading server, a distributed energy resource for a power trading to the blockchain distributed ledger through the smart contract code; registering, by a power brokerage server, a power brokerage contract related to the distributed energy resource to the blockchain distributed ledger through the smart contract code; and verifying, by a brokerage contract client, whether abnormality is present in contract contents using the distributed energy resource and the power brokerage contract stored in the blockchain distributed ledger.

The registering of the bid information may include registering, by a power brokerage server, an aggregated energy resource for a power trading to the blockchain distributed ledger through the smart contract code; verifying, by a power trading server, whether abnormality is present in the aggregated energy resource registered by the power brokerage server and storing a registration approval status of the aggregated energy resource in the blockchain distributed ledger; storing, by the power brokerage server, bid information of the aggregated energy resource in the blockchain distributed ledger through the smart contract code; and registering, by the power trading server, a bidding result for the power trading using the bid information stored in the blockchain distributed ledger.

The verifying of the authenticity may include analyzing, by a brokerage contract client, at least one of bid information, metering information, and settlement information about a power trading and verifying the authenticity of the smart contract-based power brokerage and trading.

The verifying of the authenticity may include retrieving, by the brokerage contract client, bid information for the power trading from a power brokerage server; retrieving, by the brokerage contract client, a hash value of the bid information from a smart contract blockchain device; and verifying, by the brokerage contract client, the authenticity of the power brokerage and trading using the hash value of the bid information.

The verifying of the authenticity may include retrieving, by the brokerage contract client, metering information from a power trading server; retrieving, by the brokerage contract client, a hash value of the metering information from a smart contract blockchain device; and verifying, by the brokerage contract client, the authenticity of the power brokerage and trading using the hash value of contract information.

The verifying of the authenticity may include retrieving, by the brokerage contract client, settlement information from a power trading server; retrieving, by the brokerage contract client, a hash value of the settlement information from a smart contract blockchain device; and verifying, by the brokerage contract client, the authenticity of the power brokerage and trading using the hash value of the settlement information.

The settling of the power sales revenue may include registering, by a smart power meter, metering information about a power trading to the blockchain distributed ledger; and registering, by a power trading server, settlement information about an aggregated energy resource to the blockchain distributed ledger.

Additional aspects of example embodiments will be set forth in part in the description which follows and, in part, will be apparent from the description, or may be learned by practice of the disclosure.

According to example embodiments, a power brokerage system may protect sensitive information to be shared between a contract party and a trading party and, at the same time, allow market participants to verify data integrity of power brokerage and trading information stored in a blockchain through the blockchain by sharing a smart contract code through a smart contract blockchain node and storing encrypted power brokerage and trading information and a digitally signed hash value of the power brokerage and trading information in a blockchain distributed ledger through the shared smart contract code.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a power brokerage system according to an example embodiment;

FIG. 2 is a flowchart illustrating a procedure of storing sensitive information in a power brokerage and trading process in a power brokerage method according to an example embodiment;

FIG. 3 is a flowchart illustrating a procedure of verifying the authenticity of stored sensitive information in a power brokerage method according to an example embodiment;

FIG. 4 illustrates a transaction processing procedure in a power brokerage method according to an example embodiment; and

FIG. 5 illustrates a procedure of verifying power brokerage and trading information in a power brokerage method according to an example embodiment.

### DETAILED DESCRIPTION

The following structural or functional descriptions of example embodiments described herein are merely intended for the purpose of describing the example embodiments described herein and may be implemented in various forms. However, it should be understood that these example embodiments are not construed as limited to the illustrated forms.

Various modifications may be made to the example embodiments. Here, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described in the foregoing.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments will be described in detail with reference to the accompanying drawings.

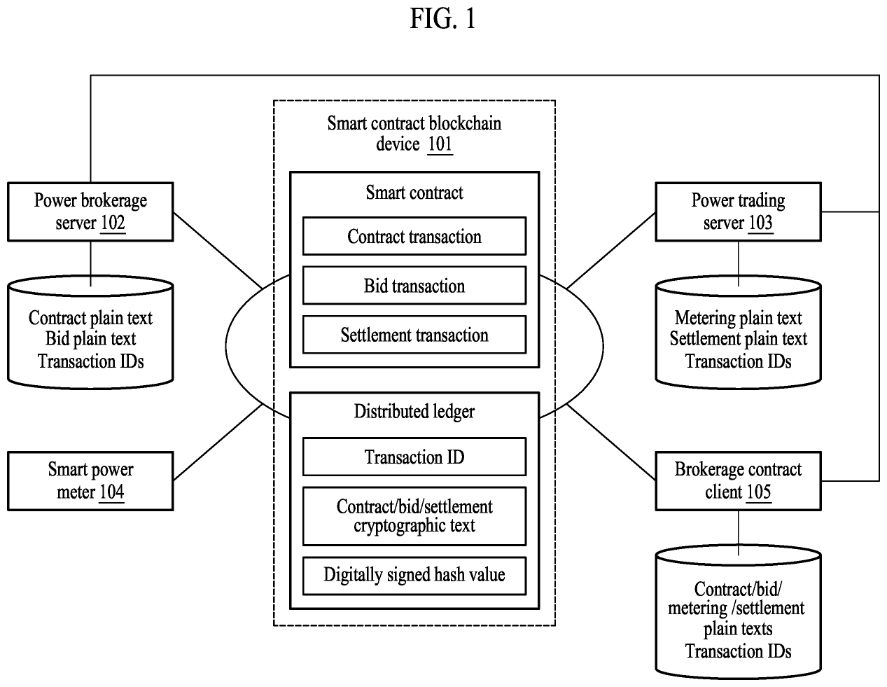

FIG. 1 is a diagram illustrating a power brokerage system according to an example embodiment.

Referring to FIG. 1, a power brokerage system may store and retrieve encrypted power brokerage and trading information and a digitally signed hash value in a blockchain distributed ledger through a smart contract code running on a blockchain platform. Also, the power brokerage system may share the encrypted power brokerage and trading information and the digitally signed hash value stored in the blockchain distributed ledger with participants that participate in the power market.

The power brokerage system may allow a participant to retrieve original data related to the power brokerage and trading information from a power brokerage server 102 and a power trading server 103. The power brokerage system may verify whether original data related to the retrieved power brokerage and trading information is forged/falsified. In this manner, the power brokerage system may protect sensitive information related to a brokerage trading contract and settlement and may also ensure transparency of brokerage contract and trading.

To this end, the power brokerage system may include a smart contract blockchain device 101, the power brokerage server 102, the power trading server 103, a smart power meter 104, and a brokerage contract client 105. Each component may operate as follows.

The smart contract blockchain device 101 may generate a transaction related to a power trading through a smart contract code running on a blockchain platform and may store the generated transaction in a blockchain distributed ledger. In detail, the smart contract blockchain device 101 may execute the smart contract code on the blockchain platform in response to a request from at least one of the power brokerage server 102, the power trading server 103, and the smart power meter 104. The smart contract blockchain device 101 may generate at least one transaction among a brokerage contract transaction, a bid transaction, and a settlement transaction by executing the smart contract code.

The smart contract blockchain device 101 may store and manage the generated transaction in the blockchain distributed ledger. The smart contract blockchain device 101 may provide a transaction ID for a transaction search in the blockchain distributed ledger to at least one of the power brokerage server 102, the power trading server 103, and the smart power meter 104.

The power brokerage server 102 may request the smart contract blockchain device 101 for execution of the smart contract code related to a brokerage contract or a bid, and may store, in the blockchain distributed ledger, a transaction including a digitally signed hash value and a cryptographic text of the brokerage contract or the bid. Here, the power brokerage server 102 may generate brokerage contract or bid information and may store original data related thereto in an off-chain database. The power brokerage server 102 may share the original data related to the brokerage contract or the bid information stored in the off-chain database with a user having a corresponding access right.

The power brokerage server 102 may request the smart contract blockchain device 101 for execution of the smart contract code for the brokerage contract or the bid and may record the transaction including the digitally signed hash value and the cryptographic text of brokerage contract and bid information in the blockchain distributed ledger. The power brokerage server 102 may share the transaction recorded in the blockchain distributed ledger with participants that participate in the power market.

The power trading server 103 may request the smart contract blockchain device 101 for execution of the smart contract code related to a settlement and may store a transaction including a digitally signed hash value and a cryptographic text of settlement information in the blockchain distributed ledger. In detail, the power trading server 103 may receive and store metering information from the smart power meter 104. The power trading server 103 may generate settlement information based on the stored metering information. The power trading server 103 may store original data related to the settlement information in the off-chain database. Then, the power trading server 103 may share the original data related to the settlement information stored in the off-chain database with a user having a corresponding access right.

The power trading server 103 may request the smart contract blockchain device 101 for execution of the smart contract code related to the settlement and then record the transaction including a digitally signed hash value and the cryptographic text of the settlement information in the blockchain distributed ledger. The power trading server 103 may share the transaction with participants that participate in the power market.

The smart power meter 104 may request the smart contract blockchain device 101 for execution of the smart contract code and may store a transaction including a digitally signed hash value of metering information in the blockchain distributed ledger. The smart power meter 104 may store the transaction including the digitally signed hash value of the metering information in the blockchain distributed ledger by requesting the smart contract blockchain device 101 for execution of the smart contract code. The smart power meter 104 may transmit a transaction ID and original data related to the metering information to the power trading server 103.

The brokerage contract client 105 may verify whether original data related to brokerage contract information managed by at least one of the power trading server 103 and the power brokerage server 102 is forged and falsified using the digitally signed hash value of the blockchain distributed ledger.

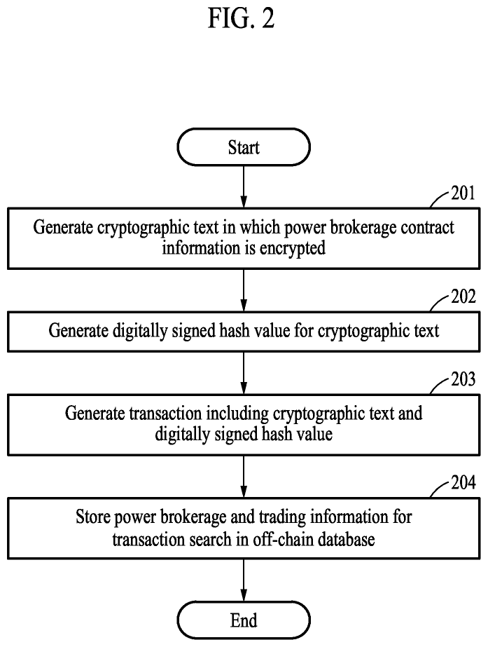

FIG. 2 is a flowchart illustrating a procedure of storing sensitive information in a power brokerage and trading process in a power brokerage method according to an example embodiment.

The flowchart of FIG. 2 relates to the procedure of storing sensitive information in the power brokerage and trading process in the power brokerage method and may operate in a power trading server or/and a power brokerage server. Hereinafter, for description, the power trading server or/and the power brokerage server is collectively referred to as a power brokerage and trading server.

Referring to FIG. 2, in operation 201, the power brokerage and trading server may generate a cryptographic text in which power brokerage and trading information is encrypted using a public key encryption scheme to share the power brokerage and trading information through a blockchain distributed ledger. The power brokerage and trading server may encrypt the power brokerage and trading information using a public key of a counterpart that is to confirm and verify the power brokerage and trading information and may generate the cryptographic text according thereto. Then, the power brokerage and trading server may share the generated cryptographic text through the blockchain distributed ledger.

In operation 202, the power brokerage and trading server may generate a digitally signed hash value for the generated cryptographic text by applying a hash algorithm. The power brokerage and trading server may generate a hash value corresponding to the power brokerage and trading information encrypted in operation 201 by applying the hash algorithm. The power brokerage and trading server may generate the digitally signed hash value by digitally signing the generated hash value using a secret key.

In operation 203, the power brokerage and trading server may request a smart contract blockchain device for execution of a smart contract code for a power brokerage and trading and then generate a transaction including the cryptographic text and the digitally signed hash value, and store the transaction in the blockchain distributed ledger.

In operation 204, the power brokerage and trading server may store, in an off-chain database, a transaction ID for searching for the transaction stored in the blockchain distributed ledger and original data related to the power brokerage and trading information.

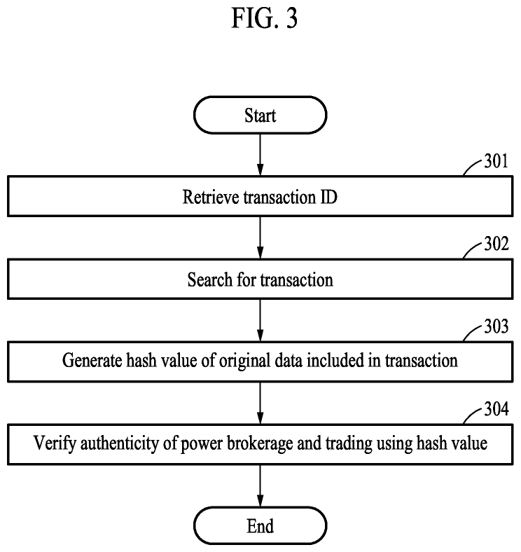

FIG. 3 is a flowchart illustrating a procedure of verifying the authenticity of stored sensitive information in a power brokerage method according to an example embodiment.

The flowchart of FIG. 3 refers to the procedure of verifying the authenticity of stored sensitivity information in the power brokerage method and may operate in a brokerage contract client.

Referring to FIG. 3, in operation 301, the brokerage contract client may retrieve a transaction ID and original data of power brokerage and trading information stored in an off-chain database of a power brokerage server and a power trading server.

In operation 302, the brokerage contract client may request a smart contract blockchain device for execution of a smart contract code using the transaction ID retrieved from the off-chain database and may search for a transaction including a cryptographic text and a digitally signed hash value of power brokerage and trading information.

In operation 303, the brokerage contract client may generate a hash value for authenticity verification by encrypting the original data of power brokerage and trading information retrieved from the off-chain database.

In operation 304, the brokerage contract client may compare the digitally signed hash value and the hash value for authenticity verification and may verify the authenticity of a power brokerage and trading. In detail, the brokerage contract client may decrypt the digitally signed hash value with a public key of a digital signer and generate the decrypted hash value. The brokerage contract client may determine whether the decrypted hash value and the hash value for authenticity verification match and verify the authenticity of the power brokerage and trading.

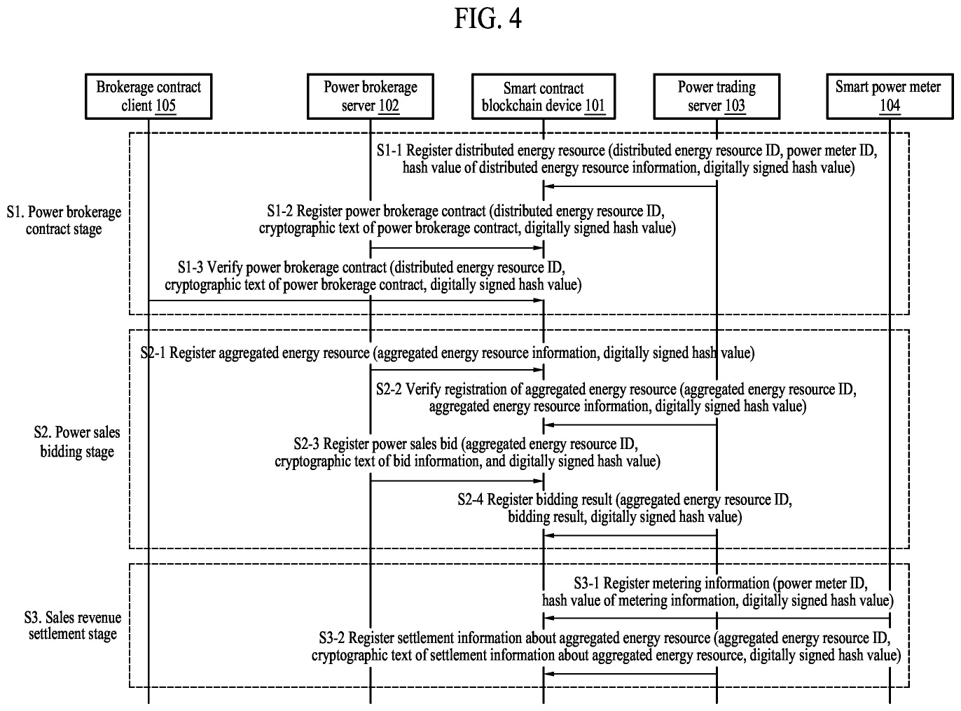

FIG. 4 illustrates a transaction processing procedure in a power brokerage method according to an example embodiment.

The flowchart of FIG. 4 refers to the transaction processing procedure in the power brokerage method and may include operations among the smart contract blockchain device 101, the power brokerage server 102, the power trading server 103, the smart power meter 104, and the brokerage contract client 105.

The method may largely include \textcircled{1} Power brokerage contract stage, \textcircled{2} Power sales bidding stage, \textcircled{3} Sales revenue settlement stage, and \textcircled{4} Authenticity verification stage.

\textcircled{1} Power Brokerage Contract Stage (S1)

The power brokerage system may perform the power brokerage contract stage of verifying a power brokerage contract for a distributed energy resource through a smart contract code of the smart contract blockchain device 101.

In operation S1-1, the power trading server 103 may register a distributed energy resource for a power trading through the smart contract code to a blockchain distributed ledger of the smart contract blockchain device 101. In detail, the power trading server 103 may generate a transaction through the smart contract code of the smart contract blockchain device 101. Here, the transaction may include a distributed energy resource ID, a power meter ID, a hash value of distributed energy resource information, and a digitally signed hash value.

The power trading server 103 may request the smart contract blockchain device 101 to store the generated transaction in the blockchain distributed ledger and may receive and store a transaction ID for a transaction search as an acknowledgement (ACK) response to the request.

In operation S1-2, the power brokerage server 102 may register a power brokerage contract related to a distributed energy resource to the blockchain distributed ledger through the smart contract code of the smart contract blockchain device 101. In detail, the power brokerage server 102 may store, in the blockchain distributed ledger, and request a cryptographic text of power brokerage contract information encrypted with a public key of a resource holder and a hash value in which the power brokerage contract information is encrypted with a secret key of a power broker through the smart contract code of the smart contract blockchain device 101. The power brokerage server 102 may register the power brokerage contract by updating a state of the updated distributed energy resource and then receiving and storing the corresponding transaction ID.

In operation S1-3, the brokerage contract client 105 may verify whether abnormality is present in contract contents by decrypting the cryptographic text of the power brokerage contract information recorded in the blockchain distributed ledger with a secret key of a resource holder. The brokerage contract client 105 may store, in the blockchain distributed ledger, a hash value digitally signed with the secret key of the resource holder based on a verification result.

The brokerage contract client 105 may verify the power brokerage contract by updating a state of the power brokerage contract of the distributed energy resource registered in operation S1-2 and then receiving and storing the corresponding transaction ID.

\textcircled{2} Power Sales Bidding Stage (S2)

In operation S2-1, the power brokerage server 102 may register an aggregated energy resource for the power trading to the blockchain distributed ledger through the smart contract code. The power brokerage server 102 may store, in the blockchain distributed ledger, aggregated energy resource information and a hash value in which the aggregated energy resource information is digitally signed with the secret key of the power broker through the smart contract code of the smart contract blockchain device 101. The power brokerage server 102 may receive and store the transaction ID according to storage.

In operation S2-2, the power trading server 103 may verify whether abnormality is present in the aggregated energy resource registered by the power brokerage server 102 and may store a registration approval status of the aggregated energy resource in the blockchain distributed ledger. The power trading server 103 may verify whether the abnormality is present in the aggregated energy resource recorded in the blockchain distributed ledger and then may store, in the blockchain distributed ledger, a hash value digitally signed with a secret key of a power brokerage manager and an allocated aggregated energy resource ID. The power trading server 103 may update a state of the aggregated energy resource registered in operation S2-1 and then may receive and store the corresponding transaction ID.

In operation S2-3, the power brokerage server 102 may store bid information of the aggregated energy resource in the blockchain distributed ledger through the smart contract code. In detail, the power brokerage server 102 may store, in the blockchain distributed ledger, a cryptographic text of bid information encrypted with a public key of the power brokerage manager and a hash value in which the bid information is digitally signed with the secret key of the power broker through the smart contract code of the smart contract blockchain device 101. The power brokerage server 102 may register the bid information of the aggregated energy resource of which registration is completed in operation S2-2 and then may receive and store the corresponding transaction ID.

In operation S2-4, the power trading server 103 may register a bidding result for the power trading using the bid information stored in the blockchain distributed ledger. The power trading server 103 may verify bidding contents by decrypting the cryptographic text of the bid information recorded in the blockchain distributed ledger with the secret key of the power brokerage manager. The power trading server 103 may store, in the blockchain distributed ledger, the bidding result and a hash value in which a result value of the bidding result is digitally signed with the secret key of the power brokerage manager. The power trading server 103 may update the bid information of the aggregated energy resource registered in operation S2-3 and then may receive and store the corresponding transaction ID.

\textcircled{3} Sales Revenue Settlement Stage (S3)

In operation S3-1, the smart power meter 104 may register metering information about the power trading to the blockchain distributed ledger. The smart power meter 104 may store a power meter ID, a hash value of metering information, and a hash value digitally signed for the hash value in the blockchain distributed ledger through the smart contract code of the smart contract blockchain device 101 and may receive the corresponding transaction ID.

In operation S3-2, the power trading server 103 may register settlement information about the aggregated energy resource to the blockchain distributed ledger. The power trading server 103 may store, in the blockchain distributed ledger, a cryptographic text of the settlement information encrypted through a public key of the power broker and a hash value in which the settlement information is digitally signed with the secret key of the power brokerage manager through the smart contract code of the smart contract blockchain device 101.

The power trading server 103 may register the settlement information about the aggregated energy resource of which registration is completed in operation S2-2 and then may receive and store the corresponding transaction ID.

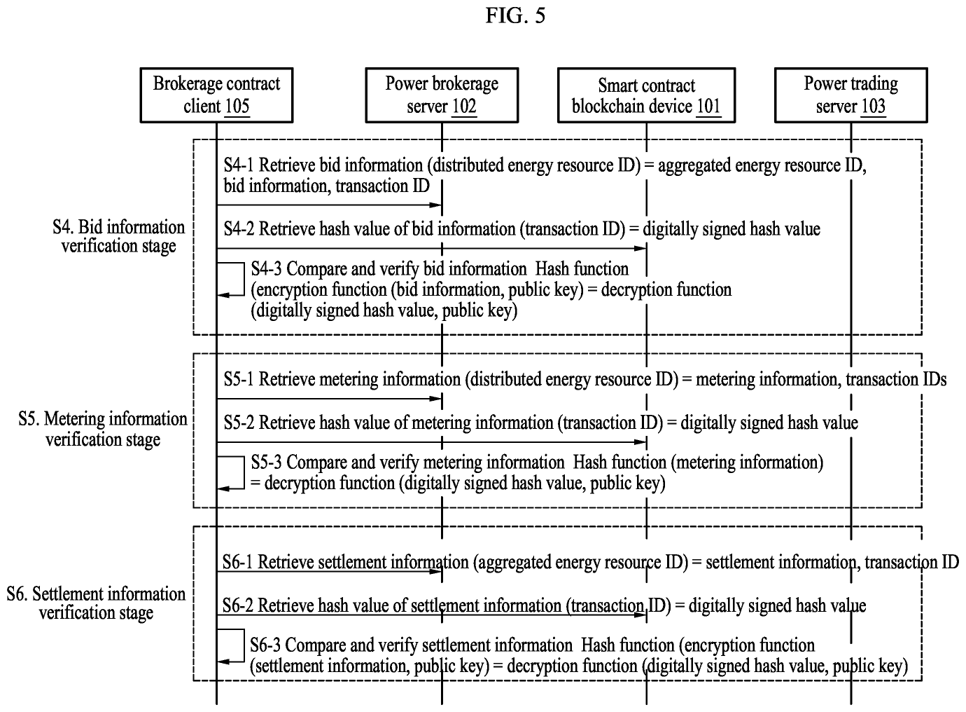

\textcircled{4} Authenticity Verification Stage The power brokerage system may verify the authenticity of a smart contract-based power brokerage and trading in response to the power brokerage contract, bidding, or settlement. Here, the authenticity may include a bid information verification, a metering information verification, and a settlement information verification, and the authenticity verification stage is further described with reference to FIG. 5.

FIG. 5 illustrates a procedure of verifying power brokerage and trading information in a power brokerage method according to an example embodiment.

The flowchart of FIG. 5 refers to the procedure of verifying power brokerage and trading information in the power brokerage method and may be configured as operations among the smart contract blockchain device 101, the power brokerage server 102, the power trading server 103, and the brokerage contract client 105.

The power brokerage system may analyze at least one of bid information, metering information, and settlement information about the power trading and may verify the authenticity of the smart contract-based power brokerage and trading through the brokerage contract client 105.

The method may largely include \textcircled{4} Bid information verification stage, \textcircled{5} Metering information verification stage, and \textcircled{6} Settlement information verification stage.

\textcircled{4} Bid Information Verification Stage (S4)

In operation S4-1, the brokerage contract client 105 may retrieve bid information for the power trading from the power brokerage server 102. In detail, the brokerage contract client 105 may retrieve an aggregated energy resource ID, original data related to the bid information, and a transaction ID from the power brokerage server 102 using a distributed energy resource ID.

In operation S4-2, the brokerage contract client 105 may retrieve a hash value of the bid information from the smart contract blockchain device 101. The brokerage contract client 105 may retrieve a digitally signed hash value of the bid information recorded in the blockchain distributed ledger of the smart contract blockchain device 101 using the transaction ID received in operation S4-1.

In operation S4-3, the brokerage contract client 105 may verify the authenticity of the power brokerage and trading using the hash value of the bid information. The brokerage contract client 105 may verify whether a hash value generated by encrypting the original data related to the bid information received in operation S4-1 with a public key of the power brokerage manager and by applying the hash algorithm and a value generated by decrypting the digitally signed hash value received in operation S4-2 with the public key of the power broker match. The brokerage contract client 105 may verify whether the bid information is forged/falsified by verifying whether they match.

\textcircled{5} Metering Information Verification Stage (S5)

In operation S5-1, the brokerage contract client 105 may retrieve metering information from the power trading server 103. The brokerage contract client 105 may retrieve the metering information and the transaction ID from the power brokerage server 102 using the distributed energy resource ID.

In operation S5-2, the brokerage contract client 105 may retrieve a hash value of the metering information from the smart contract blockchain device 101. The brokerage contract client 105 may retrieve a digitally signed hash value of the metering information recorded in the blockchain distributed ledger of the smart contract blockchain device 101 using the transaction ID received in operation S5-1.

In operation S5-3, the brokerage contract client 105 may verify the authenticity of the power brokerage and trading using the hash value of contract information. The brokerage contract client 105 may verify whether a hash value generated by applying the hash algorithm to the metering information received in operation S5-1 and a value obtained by decrypting the digitally signed hash value received in operation S5-2 with the public key of the power brokerage manager match. The brokerage contract client 105 may verify whether the metering information is forged/falsified by verifying whether they match.

\textcircled{6} Settlement Information Verification Stage (S6)

In operation S6-1, the brokerage contract client 105 may retrieve settlement information from the power trading server 103. The brokerage contract client 105 may retrieve original data related to the settlement information and a transaction ID from the power trading server 103 using the aggregated energy resource ID secured in operation S3-1.

In operation S6-2, the brokerage contract client 105 may retrieve a hash value of the settlement information from the smart contract blockchain device 101. The brokerage contract client 105 may retrieve a digitally signed hash value of the settlement information recorded in the blockchain distributed ledger of the smart contract blockchain device 101 using the transaction ID received in operation S6-1.

In operation S6-3, the brokerage contract client 105 may verify the authenticity of the power brokerage and trading using the hash value of the settlement information. The brokerage contract client 105 may verify whether a hash value generated by encrypting the original data related to the settlement information received in operation S6-1 with a public key of the power broker and then applying the hash algorithm and a value generated by decrypting the digitally signed hash value received in operation S6-2 with the public key of the power brokerage manager match. The brokerage contract client 105 may verify whether the settlement information is forged/falsified by verifying whether they match.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or digitally erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A power brokerage system comprising:
a smart contract blockchain device configured to generate a transaction related to a power trading through a smart contract code running on a blockchain platform and to store the generated transaction in a blockchain distributed ledger;
a smart power meter configured to request the smart contract blockchain device for execution of the smart contract code and to store a transaction including a digitally signed hash value of metering information in the blockchain distributed ledger;
a power trading server configured to request the smart contract blockchain device for execution of the smart contract code related to a settlement and to store a transaction including a digitally signed hash value and a cryptographic text of settlement information in the blockchain distributed ledger;
a power brokerage server configured to request the smart contract blockchain device for execution of the smart contract code related to a brokerage contract or a bid, and to store a transaction including a digitally signed hash value and a cryptographic text of the brokerage contract or the bid in the blockchain distributed ledger; and
a brokerage contract client configured to verify whether brokerage contract information managed by at least one of the power trading server and the power brokerage server is forged and falsified using the digitally signed hash value of the blockchain distributed ledger.

2. The power brokerage system of claim 1, wherein the smart contract blockchain device is configured to execute the smart contract code in response to a request from at least one of the power trading server and the power brokerage server and to generate at least one transaction among a brokerage contract transaction, a bid transaction, and a settlement transaction.

3. The power brokerage system of claim 2, wherein the smart contract blockchain device is configured to store the transaction in the blockchain distributed ledger and then provide a transaction identification (ID) for a transaction search in the blockchain distributed ledger to at least one of the power trading server, the power brokerage server, and the smart power meter.

4. The power brokerage system of claim 1, wherein the power trading server is configured to generate settlement information according to the metering information received from the smart power meter, to store original data related to the metering information and the settlement information in an off-chain database, and share the same with a user having an access right.

5. The power brokerage system of claim 1, wherein the power brokerage server is configured to store original data related to the brokerage contract and the bid in an off-chain database and to share the same with a user having an access right.

6. The power brokerage system of claim 1, wherein the smart power meter is configured to transfer a transaction ID and original data related to the metering information to the power brokerage server.

7. A power brokerage method comprising:
retrieving, by a brokerage contract client, a transaction identification (ID) and original data of power brokerage and trading information stored in an off-chain database;
requesting a smart contract blockchain device for execution of a smart contract code using the retrieved transaction ID and searching for a transaction including a cryptographic text and a digitally signed hash value;
generating a hash value for authenticity verification by encrypting the original data of the power brokerage and trading information stored in the off-chain database; and
comparing the digitally signed hash value and the hash value for authenticity verification and verifying the authenticity of a power brokerage and trading.

8. The power brokerage method of claim 7, wherein the verifying comprises:
decrypting the digitally signed hash value with a public key of a digital signer and generating the decrypted hash value; and
determining whether the decrypted hash value and the hash value for authenticity verification match and verifying the authenticity of the power brokerage and trading.

9. A power brokerage method comprising:
concluding a power brokerage contract for a distributed energy resource through a smart contract code of a smart contract blockchain device;
registering bid information about aggregated energy resource power sales to a blockchain distributed ledger according to the power brokerage contract;
settling a power sales revenue corresponding to a bidding result; and
verifying the authenticity of a smart contract-based power brokerage and trading in response to the power brokerage contract, bid, or settlement.

10. The power brokerage method of claim 9, wherein the concluding of the power brokerage contract comprises:
registering, by a power trading server, a distributed energy resource for a power trading to the blockchain distributed ledger through the smart contract code;
registering, by a power brokerage server, a power brokerage contract related to the distributed energy resource to the blockchain distributed ledger through the smart contract code; and
verifying, by a brokerage contract client, whether abnormality is present in contract contents using the distributed energy resource and the power brokerage contract stored in the blockchain distributed ledger.

11. The power brokerage method of claim 9, wherein the registering of the bid information comprises:
registering, by a power brokerage server, an aggregated energy resource for a power trading to the blockchain distributed ledger through the smart contract code;
verifying, by a power trading server, whether abnormality is present in the aggregated energy resource registered by the power brokerage server and storing a registration approval status of the aggregated energy resource in the blockchain distributed ledger;
storing, by the power brokerage server, bid information of the aggregated energy resource in the blockchain distributed ledger through the smart contract code; and
registering, by the power trading server, a bidding result for the power trading using the bid information stored in the blockchain distributed ledger.

12. The power brokerage method of claim 9, wherein the verifying of the authenticity comprises:
analyzing, by a brokerage contract client, at least one of bid information, metering information, and settlement information about a power trading and verifying the authenticity of the smart contract-based power brokerage and trading.

13. The power brokerage method of claim 12, wherein the verifying of the authenticity comprises:
retrieving, by the brokerage contract client, bid information for the power trading from a power brokerage server;
retrieving, by the brokerage contract client, a hash value of the bid information from a smart contract blockchain device; and
verifying, by the brokerage contract client, the authenticity of the power brokerage and trading using the hash value of the bid information.

14. The power brokerage method of claim 12, wherein the verifying of the authenticity comprises:
retrieving, by the brokerage contract client, metering information from a power trading server;
retrieving, by the brokerage contract client, a hash value of the metering information from a smart contract blockchain device; and
verifying, by the brokerage contract client, the authenticity of the power brokerage and trading using the hash value of contract information.

15. The power brokerage method of claim 12, wherein the verifying of the authenticity comprises:
retrieving, by the brokerage contract client, settlement information from a power trading server;
retrieving, by the brokerage contract client, a hash value of the settlement information from a smart contract blockchain device; and
verifying, by the brokerage contract client, the authenticity of the power brokerage and trading using the hash value of the settlement information.

16. The power brokerage method of claim 9, wherein the settling of the power sales revenue comprises:
registering, by a smart power meter, metering information about a power trading to the blockchain distributed ledger; and
registering, by a power trading server, settlement information about an aggregated energy resource to the blockchain distributed ledger.
